(19) United States
(12) Patent Application Publication
(10) Pub. No.: US 2025/0190236 A1
(43) Pub. Date: Jun. 12, 2025

(54) EDGE-BASED SECURE CONTAINERIZATION

(71) Applicant: Dell Products L.P., Round Rock, TX (US)

(72) Inventors: Parminder Singh SETHI, Punjab (IN); Srinath KAPPGAL, Cork (IE); Daniel L. HAMLIN, Round Rock, TX (US); Malathi RAMAKRISHNAN, Madurai (IN); Praveen KUMAR, Noida (IN)

(73) Assignee: Dell Products L.P., Round Rock, TX (US)

(21) Appl. No.: 18/537,582

(22) Filed: Dec. 12, 2023

(51) Int. Cl. G06F 9/455

(52) U.S. Cl. CPC G06F 9/45558; G06F 2009/45562; G06F 2009/45587

(57) ABSTRACT

An information handling system may include at least one processor and a memory, and it may be an edge node of a hyper-converged infrastructure (HCI) system. The information handling system may be configured to: configured to execute a secure containerization platform configured to: execute a plurality of containerized applications; provide an isolation mechanism to prevent data from being transferred among the containerized applications; provide security services for the containerized applications, the security services including encryption, authentication, and monitoring services; provide a communication channel between the containerized applications and at least one other information handling system; provide a management and monitoring interface to the containerized applications that is accessible from the at least one other information handling system; and provide an integration component configured to integrate the secure containerization platform with infrastructure of a manufacturer of the information handling system.

### TECHNICAL FIELD

The present disclosure relates in general to information handling systems, and more particularly to providing secure process containerization, especially in an edge computing environment.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Hyper-converged infrastructure (HCI) is an IT framework that combines and networking into a single system in an effort to reduce data center complexity and increase scalability. Hyper-converged platforms may include a hypervisor for virtualized computing, software-defined storage, and virtualized networking, and they typically run on standard, off-the-shelf servers. One type of HCI solution is the Dell EMC VxRail™ system. Some examples of HCI systems may operate in various environments (e.g., an HCI management system such as the VMware® vSphere® ESXi™ environment, or any other HCI management system). Some examples of HCI systems may operate as software-defined storage (SDS) cluster systems (e.g., an SDS cluster system such as the VMware® vSAN™ system, or any other SDS cluster system).

In the HCI context (as well as other contexts), information handling systems may execute virtual machines (VMs) for various purposes. A VM may generally comprise any program of executable instructions, or aggregation of programs of executable instructions, configured to execute a guest operating system on a hypervisor or host operating system in order to act through or in connection with the hypervisor/host operating system to manage and/or control the allocation and usage of hardware resources such as memory, central processing unit time, disk space, and input and output devices, and provide an interface between such hardware resources and application programs hosted by the guest operating system.

Existing containerization solutions in both the HCI context and the non-HCI context have a number of drawbacks. For example, existing solutions exhibit a lack of isolation-edge devices often run multiple applications concurrently, and there is a need to isolate these applications from each other to prevent interference and unauthorized access. Without proper isolation, a compromise in one application can potentially impact the security and integrity of other applications and their data.

Some solutions exhibit vulnerabilities in communication. Edge devices typically interact with other systems and devices, including cloud services or other edge devices. The communication channels between these entities may lack encryption or authentication mechanisms, making them susceptible to eavesdropping, data tampering, and unauthorized access.

Existing solutions have limited security controls. Edge devices often have limited computing resources, making it challenging to implement robust security controls and monitoring mechanisms. Traditional security solutions designed for centralized systems may not be suitable for edge environments due to resource constraints.

Existing solutions also lack the ability to provide secure updates. Edge devices may require regular updates to address security vulnerabilities and add new features. However, updating edge devices securely can be challenging due to limited connectivity, intermittent network availability, and potential risks of interrupted services during the update process.

It should be noted that the discussion of a technique in the Background section of this disclosure does not constitute an admission of prior-art status. No such admissions are made herein, unless clearly and unambiguously identified as such.

### SUMMARY

In accordance with the teachings of the present disclosure, the disadvantages and problems associated with containerization in an edge environment may be reduced or eliminated.

In accordance with embodiments of the present disclosure, an information handling system may include at least one processor and a memory, and it may be an edge node of a hyper-converged infrastructure (HCI) system. The information handling system may be configured to: configured to execute a secure containerization platform configured to: execute a plurality of containerized applications; provide an isolation mechanism to prevent data from being transferred among the containerized applications; provide security services for the containerized applications, the security services including encryption, authentication, and monitoring services; provide a communication channel between the containerized applications and at least one other information handling system; provide a management and monitoring interface to the containerized applications that is accessible from the at least one other information handling: system; and provide an integration component configured to integrate the secure containerization platform with infrastructure of a manufacturer of the information handling system.

In accordance with these and other embodiments of the present disclosure, a method may include an information handling system executing a secure containerization platform; the information handling system executing, via the secure containerization platform, a plurality of containerized applications; the information handling system providing, via the secure containerization platform, an isolation mechanism to prevent data from being transferred among the containerized applications; the information handling system providing, via the secure containerization platform, security services for the containerized applications, the security services including encryption, authentication, and monitoring services; the information handling system providing, via the secure containerization platform, a communication channel between the containerized applications and at least one other information handling system; the information handling system providing, via the secure containerization platform, a management and monitoring interface to the containerized applications that is accessible from the at least one other information handling system; and the information handling system providing, via the secure containerization platform, an integration component configured to integrate the secure containerization platform with infrastructure of a manufacturer of the information handling system; wherein the information handling system is an edge node of a hyper-converged infrastructure (HCI) system.

In accordance with these and other embodiments of the present disclosure, an article of manufacture may include a non-transitory, computer-readable medium having computer-executable instructions thereon that are executable by a processor of an information handling system for: executing a secure containerization platform; executing, via the secure containerization platform, a plurality of containerized applications; providing, via the secure containerization platform, an isolation mechanism to prevent data from being transferred among the containerized applications; providing, via the secure containerization platform, security services for the containerized applications, the security services including encryption, authentication, and monitoring services; providing, via the secure containerization platform, a communication channel between the containerized applications and at least one other information handling system; providing, via the secure containerization platform, a management and monitoring interface to the containerized applications that is accessible from the at least one other information handling system; and providing, via the secure containerization platform, an integration component configured to integrate the secure containerization platform with infrastructure of a manufacturer of the information handling system; wherein the information handling system is an edge node of a hyper-converged infrastructure (HCI) system.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example information handling system, in accordance with embodiments of the present disclosure;

FIGS. 2-4 illustrate example architectures, in accordance with embodiments of the present disclosure; and

FIG. 5 illustrates a flow chart of an example method, in accordance with embodiments of the present disclosure.

### DETAILED DESCRIPTION

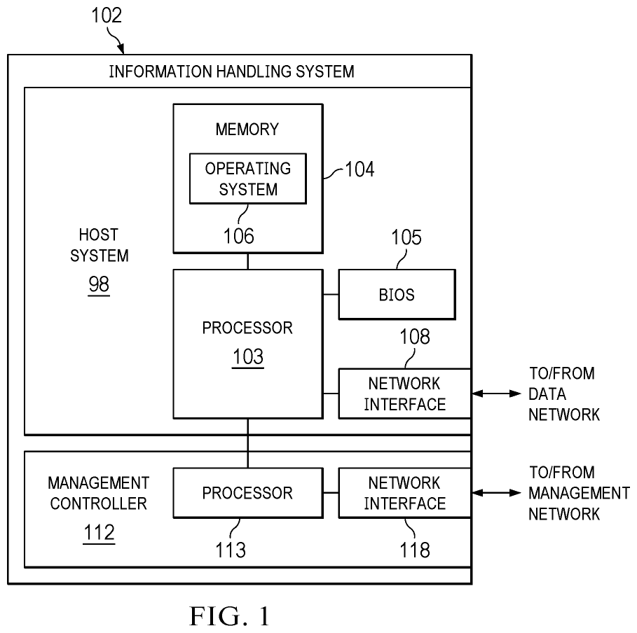

Preferred embodiments and their advantages are best understood by reference to FIGS. 1 through 5, wherein like numbers are used to indicate like and corresponding parts.

For the purposes of this disclosure, the term “information handling system” may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

For purposes of this disclosure, when two or more elements are referred to as “coupled” to one another, such term indicates that such two or more elements are in electronic communication or mechanical communication, as applicable, whether connected directly or indirectly, with or without intervening elements.

When two or more elements are referred to as “coupleable” to one another, such term indicates that they are capable of being coupled together.

For the purposes of this disclosure, the term “computer-readable medium” (e.g., transitory or non-transitory computer-readable medium) may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; communications media such as wires, optical fibers, microwaves, radio waves, and other electromagnetic and/or optical carriers; and/or any combination of the foregoing.

For the purposes of this disclosure, the term “information handling resource” may broadly refer to any component system, device, or apparatus of an information handling system, including without limitation processors, service processors, basic input/output systems, buses, memories, I/O devices and/or interfaces, storage resources, network interfaces, motherboards, and/or any other components and/or elements of an information handling system.

For the purposes of this disclosure, the term “management controller” may broadly refer to an information handling system that provides management functionality (typically out-of-band management functionality) to one or more other information handling systems. In some embodiments, a management controller may be (or may be an integral part of) a service processor, a baseboard management controller (BMC), a chassis management controller (CMC), or a remote access controller (e.g., a Dell Remote Access Controller (DRAC) or Integrated Dell Remote Access Controller (iDRAC)).

FIG. 1 illustrates a block diagram of an example information handling system 102, in accordance with embodiments of the present disclosure. In some embodiments, information handling system 102 may comprise a server chassis configured to house a plurality of servers or “blades.” In other embodiments, information handling system 102 may comprise a personal computer (e.g., a desktop computer, laptop computer, mobile computer, and/or notebook computer). In yet other embodiments, information handling system 102 may comprise a storage enclosure configured to house a plurality of physical disk drives and/or other computer-readable media for storing data (which may generally be referred to as “physical storage resources”). As shown in FIG. 1, information handling system 102 may comprise a processor 103, a memory 104 communicatively coupled to processor 103, a BIOS 105 (e.g., a UEFI BIOS) communicatively coupled to processor 103, a network interface 108 communicatively coupled to processor 103, and a management controller 112 communicatively coupled to processor 103.

In operation, processor 103, memory 104, BIOS 105, and network interface 108 may comprise at least a portion of a host system 98 of information handling system 102. In addition to the elements explicitly shown and described, information handling system 102 may include one or more other information handling resources.

Processor 103 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104 and/or another component of information handling system 102.

Memory 104 may be communicatively coupled to processor 103 and may include any system, device, or apparatus configured to retain program instructions and/or data for a period of time (e.g., computer-readable media). Memory 104 may include RAM, EEPROM, a PCMCIA card, flash memory, magnetic storage, opto-magnetic storage, or any suitable selection and/or array of volatile or non-volatile memory that retains data after power to information handling system 102 is turned off.

As shown in FIG. 1, memory 104 may have stored thereon an operating system 106. Operating system 106 may comprise any program of executable instructions (or aggregation of programs of executable instructions) configured to manage and/or control the allocation and usage of hardware resources such as memory, processor time, disk space, and input and output devices, and provide an interface between such hardware resources and application programs hosted by operating system 106. In addition, operating system 106 may include all or a portion of a network stack for network communication via a network interface (e.g., network interface 108 for communication over a data network). Although operating system 106 is shown in FIG. 1 as stored in memory 104, in some embodiments operating system 106 may be stored in storage media accessible to processor 103, and active portions of operating system 106 may be transferred from such storage media to memory 104 for execution by processor 103.

Network interface 108 may comprise one or more suitable systems, apparatuses, or devices operable to serve as an interface between information handling system 102 and one or more other information handling systems via an in-band network. Network interface 108 may enable information handling system 102 to communicate using any suitable transmission protocol and/or standard. In these and other embodiments, network interface 108 may comprise a network interface card, or “NIC.” In these and other embodiments, network interface 108 may be enabled as a local area network (LAN)-on-motherboard (LOM) card.

Management controller 112 may be configured to provide management functionality for the management of information handling system 102. Such management may be made by management controller 112 even if information handling system 102 and/or host system 98 are powered off or powered to a standby state. Management controller 112 may include a processor 113, memory, and a network interface 118 separate from and physically isolated from network interface 108.

As shown in FIG. 1, processor 113 of management controller 112 may be communicatively coupled to processor 103. Such coupling may be via a Universal Serial Bus (USB), System Management Bus (SMBus), and/or one or more other communications channels.

Network interface 118 may be coupled to a management network, which may be separate from and physically isolated from the data network as shown. Network interface 118 of management controller 112 may comprise any suitable system, apparatus, or device operable to serve as an interface between management controller 112 and one or more other information handling systems via an out-of-band management network. Network interface 118 may enable management controller 112 to communicate using any suitable transmission protocol and/or standard. In these and other embodiments, network interface 118 may comprise a network interface card, or “NIC.” Network interface 118 may be the same type of device as network interface 108, or in other embodiments it may be a device of a different type.

As discussed above, embodiments of this disclosure provide improvements in management of containerized applications in information handling systems 102 (e.g., edge nodes in an HCI deployment). It should be noted that while the scenario of an edge deployment is discussed in detail herein for the sake of concreteness, other embodiments are also specifically contemplated within the scope of this disclosure.

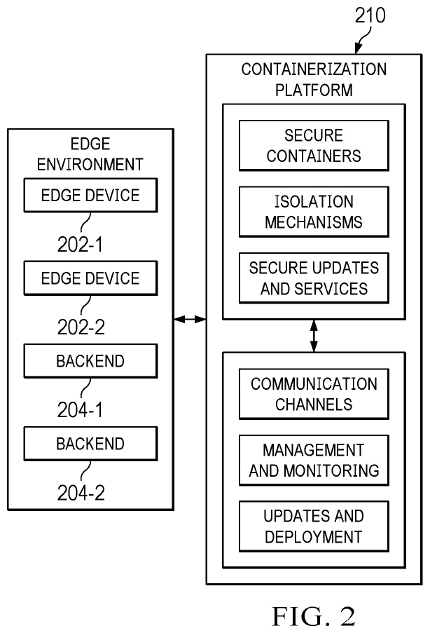

FIG. 2 illustrates an embodiment of a secure containerization platform 210 that addresses these and other issues in the context of an edge environment comprising edge devices 202 and backends 204.

Secure containerization according to the present disclosure allows for a containerization approach to isolate applications and their data on edge devices, providing a secure execution environment. This disclosure focuses specifically on edge devices, which are located closer to their data source(s). This context introduces unique security challenges that require tailored solutions.

Isolation mechanisms may use sandboxing or virtualization to prevent unauthorized access and interference between applications. This emphasizes the need for isolation mechanisms to separate applications and their data on edge devices, preventing unauthorized access and interference.

Encryption and authentication mechanisms are used for secure communication between edge devices, cloud services, and other entities in the ecosystem.

Access controls are used to establish granular access control policies and mechanisms to ensure only authorized users or entities can access the containerized applications and their data.

Image management techniques provide a process for building, storing, and distributing container images securely, including mechanisms for image signing and verification to ensure integrity.

Secure deployment tools are used that take into account limited resources and intermittent connectivity on edge devices, enabling secure and automated updates of containerized applications.

Monitoring and auditing solutions are used to detect anomalies and potential security breaches, and integrate logging mechanisms for auditing and analysis of security events.

Testing and validation techniques allow for comprehensive testing, including vulnerability assessments and penetration testing, to identify and address potential security weaknesses in the containerization solution.

Documentation and training are used to create detailed documentation, including user guides and technical documentation, to support administrators and end-users in utilizing the secure containerization solution effectively and adhering to security practices.

By implementing these measures, embodiments provide a robust and secure containerization solution for edge devices.

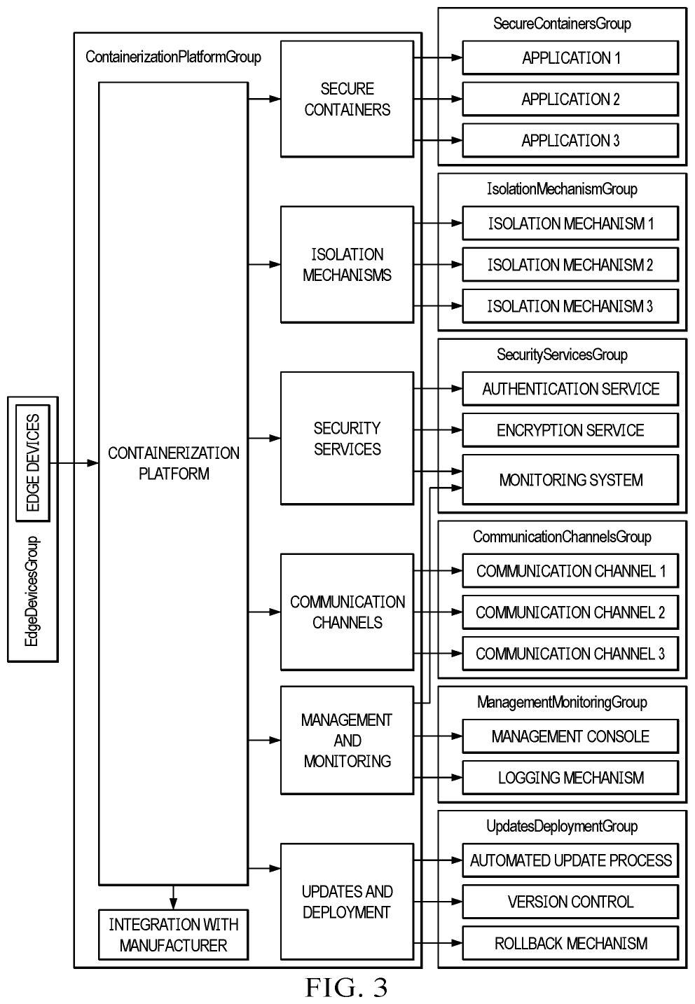

FIG. 3 provides a high-level diagram of a system architecture, according to some embodiments. The Containerization Platform is the central hub responsible for managing the containerization process on the edge devices. The Secure Containers are individual containers that encapsulate applications and their dependencies, ensuring a secure and isolated execution environment. The Isolation Mechanisms are mechanisms employed to ensure isolation between containers, preventing unauthorized access and interference. Security Services are services integrated into the containerization platform to enhance security, including authentication, and monitoring. Communication encryption, Channels are channels that enable secure communication between containers, edge devices, and external entities. Management and Monitoring provides tools and services for managing and monitoring the containerized applications and the edge devices. Updates and Deployment provides mechanisms for securely updating and deploying containerized applications on the edge devices. Integration with Manufacturer provides integration points with the manufacturer's ecosystem, leveraging their existing hardware, software, and management tools.

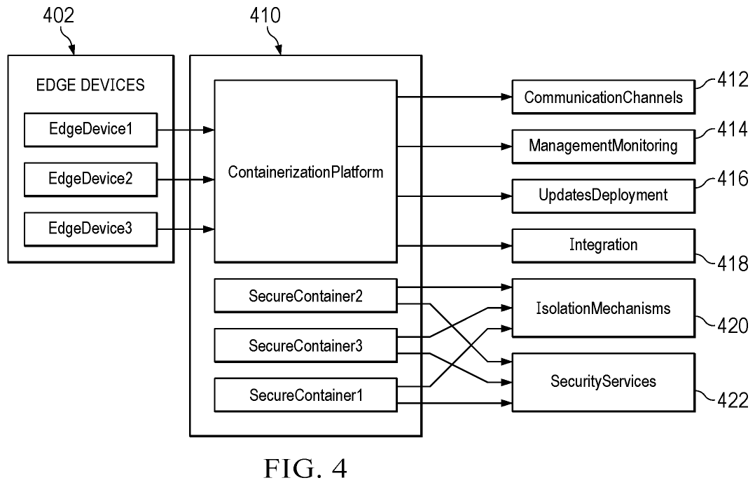

FIG. 4 provides an additional architecture diagram. In additional detail, some of the components may be described as follows.

Edge devices 402 are the physical devices located at the edge of the network, such as internet-of-things (IoT) devices, edge gateways, and/or edge servers.

Containerization platform 410 is a platform for managing and orchestrating containers on edge devices. In some embodiments, it may include existing containerization technologies (e.g., Docker, Kubernetes, etc.) adapted for edge computing environments, such that the containers are built according to existing standards. Containerization platform 410 includes secure containers, which are the individual containers that encapsulate applications and their dependencies. Each container provides a secure and isolated execution environment for the applications running on the edge devices.

Communication channels 412 includes the communication channels between edge devices, cloud services, and other entities in the ecosystem. It may include wired or wireless connections, as well as protocols and encryption mechanisms to ensure secure data exchange.

Management and monitoring 414 includes the tools and services for managing and monitoring the containerized applications and edge devices. It may include a management console, monitoring systems, and logging mechanisms to track security events and performance metrics.

Updates and deployment 416 includes the mechanisms for securely updating and deploying containerized applications on the edge devices. It may include automated update processes, version control, and roll-back mechanisms to ensure uninterrupted services during updates.

Integration 418 illustrates the integration points with the manufacturer's ecosystem, such as existing hardware, software, or management tools. It showcases how the secure containerization solution aligns with existing offerings and leverages their capabilities.

Isolation mechanisms 420 includes mechanisms configured to ensure isolation between containers and prevent unauthorized access or interference. In some embodiments, these may include technologies such as container sandboxing, lightweight virtualization, and/or hardware-based isolation mechanisms.

Security services 422 includes the security services that are integrated into the containerization solution. It may include encryption and authentication services for secure communication, access control mechanisms, image signing and verification, as well as monitoring and auditing capabilities.

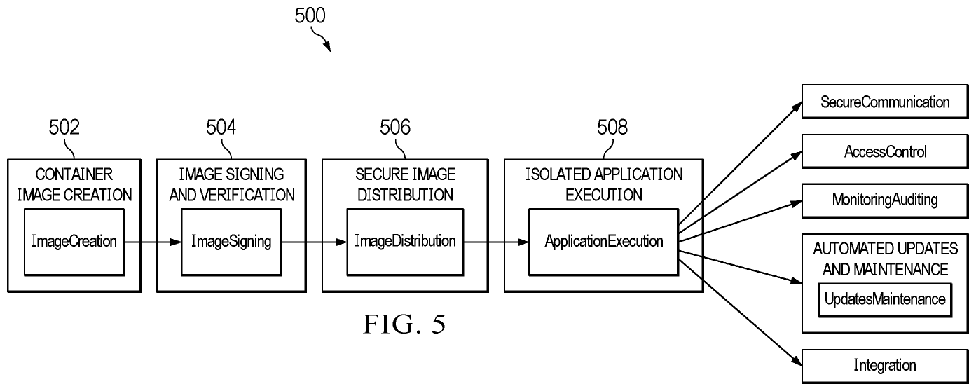

FIG. 5 illustrates a flow chart of example method 500. At step 502, container images may be created for the desired applications and their dependencies. This step may include defining the application requirements, selecting the appropriate base images, the necessary configuring environment, and building the container images using containerization tools (e.g., Docker, etc.).

At step 504, the container images may be signed with digital signatures to ensure their integrity and authenticity. This step may include generating cryptographic signatures using algorithms secure and storing the signatures securely. During deployment, the signatures may be verified to ensure that only trusted and unaltered images are used.

At step 506 the container images may be securely distributed to the edge devices. This may be achieved through a secure image registry or repository that ensures encrypted transmission and access control. The edge devices may retrieve the images securely from the registry when needed.

At step 508, when an edge device receives the container image, it may execute the application in an isolated environment. The containerization platform on the edge device creates an isolated container instance based on the image, ensuring that the application runs in a secure and contained manner, separate from other applications and the underlying operating system.

During application execution, the containerization platform may provide many services. For example, a secure communication component may provide secure communication between the containerized application running on the edge device and other entities such as cloud services or remote management systems. This may include providing encryption and authentication mechanisms to protect data exchange and ensure secure communication channels.

An access control component may provide granular access control mechanisms to restrict access to the containerized applications and their data. This ensures that only authorized entities or users can interact with the applications, preventing unauthorized access and potential security breaches.

A monitoring and auditing component may monitor execution of the containerized applications and edge devices to detect anomalies, performance issues, or potential security breaches. This may include logging security events, performance metrics, and relevant system information for auditing purposes, enabling proactive security measures and analysis of system behavior.

An automated update and maintenance component may enable automated updates and maintenance of the containerized applications on the edge devices. This may include mechanisms for delivering updates, version control, and roll-back options to ensure the applications remain up-to-date and secure without causing disruption to the services running on the edge devices.

An integration component may integrate the secure containerization solution with an existing software ecosystem such as the information handling system manufacturer's ecosystem. This integration may leverage management tools, hardware capabilities, and additional security services to enhance the overall solution and align it with existing offerings.

One of ordinary skill in the art with the benefit of this disclosure will understand that the preferred initialization points for the method depicted in FIG. 5 and the order of the steps comprising the method may depend on the implementation chosen. In these and other embodiments, the method may be implemented as hardware, firmware, software, applications, functions, libraries, or other instructions. Further, although FIG. 5 discloses a particular number of steps to be taken with respect to the disclosed method, the method may be executed with greater or fewer steps than depicted. The method may be implemented using any of the various components disclosed herein (such as the components of FIG. 1), and/or any other system operable to implement the methods.

This disclosure encompasses all changes, substitutions, variations, alterations, and modifications to the exemplary embodiments herein that a person having ordinary skill in the art would comprehend. Similarly, where appropriate, the appended claims encompass all changes, substitutions, variations, alterations, and modifications to the exemplary embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

Further, reciting in the appended claims that a structure is “configured to” or “operable to” perform one or more tasks is expressly intended not to invoke 35 U.S.C. § 112(f) for that claim element. Accordingly, none of the claims in this application as filed are intended to be interpreted as having means-plus-function elements. Should Applicant wish to invoke § 112(f) during prosecution, Applicant will recite claim elements using the “means for [performing a function]” construct.

All examples and conditional language recited herein are intended for pedagogical objects to aid the reader in understanding the invention and the concepts contributed by the inventor to furthering the art, and are construed as being without limitation to such specifically recited examples and conditions. Although embodiments of the present inventions have been described in detail, it should be understood that various changes, substitutions, and alterations could be made hereto without departing from the spirit and scope of the disclosure.

What is claimed is:

1. An information handling system comprising:
at least one processor; and
a memory;
wherein the information handling system is configured to execute a secure containerization platform configured to:
execute a plurality of containerized applications;
provide an isolation mechanism to prevent data from being transferred among the containerized applications;
provide security services for the containerized applications, the security services including encryption, authentication, and monitoring services;
provide a communication channel between the containerized applications and at least one other information handling system;
provide a management and monitoring interface to the containerized applications that is accessible from the at least one other information handling system; and
provide an integration component configured to integrate the secure containerization platform with infrastructure of a manufacturer of the information handling system;
wherein the information handling system is an edge node of a hyper-converged infrastructure (HCI) system.

2. The information handling system of claim 1, wherein the containerized applications are configured to execute within secure containers that encapsulate the containerized applications and their dependencies.

3. The information handling system of claim 1, wherein the secure containerization system is configured to provide updates to the containerized applications.

4. The information handling system of claim 1, wherein the secure containerization system is configured to provide a deployment component operable to create containers for the containerized applications.

5. The information handling system of claim 4, wherein the containers are created in accordance with a Docker standard.

6. The information handling system of claim 4, wherein the containers are created in accordance with a Kubernetes standard.

7. A method comprising:
an information handling system executing a secure containerization platform;
the information handling system executing, via the secure containerization platform, a plurality of containerized applications;
the information handling system providing, via the secure containerization platform, an isolation mechanism to prevent data from being transferred among the containerized applications;
the information handling system providing, via the secure containerization platform, security services for the containerized applications, the security services including encryption, authentication, and monitoring services;
the information handling system providing, via the secure containerization platform, a communication channel between the containerized applications and at least one other information handling system;
the information handling system providing, via the secure containerization platform, a management and monitoring interface to the containerized applications that is accessible from the at least one other information handling system; and
the information handling system providing, via the secure containerization platform, an integration component configured to integrate the secure containerization platform with infrastructure of a manufacturer of the information handling system;
wherein the information handling system is an edge node of a hyper-converged infrastructure (HCI) system.

8. The method of claim 7, wherein the containerized applications are configured to execute within secure containers that encapsulate the containerized applications and their dependencies.

9. The method of claim 8, wherein the secure containerization system is configured to provide updates to the containerized applications.

10. The method of claim 7, wherein the secure containerization system is configured to provide a deployment component operable to create containers for the containerized applications.

11. The method of claim 10, wherein the containers are created in accordance with a Docker standard.

12. The method of claim 10, wherein the containers are created in accordance with a Kubernetes standard.

13. An article of manufacture comprising a non-transitory, computer-readable medium having computer-executable instructions thereon that are executable by a processor of an information handling system for:
executing a secure containerization platform;
executing, via the secure containerization platform, a plurality of containerized applications;
providing, via the secure containerization platform, an isolation mechanism to prevent data from being transferred among the containerized applications;
providing, via the secure containerization platform, security services for the containerized applications, the security services including encryption, authentication, and monitoring services;
providing, via the secure containerization platform, a communication channel between the containerized applications and at least one other information handling system;
providing, via the secure containerization platform, a management and monitoring interface to the containerized applications that is accessible from the at least one other information handling system; and
providing, via the secure containerization platform, an integration component configured to integrate the secure containerization platform with infrastructure of a manufacturer of the information handling system;
wherein the information handling system is an edge node of a hyper-converged infrastructure (HCI) system.

14. The article of claim 13, wherein the containerized applications are configured to execute within secure containers that encapsulate the containerized applications and their dependencies.

15. The article of claim 14, wherein the secure containerization system is configured to provide updates to the containerized applications.

16. The article of claim 13, wherein the secure containerization system is configured to provide a deployment component operable to create containers for the containerized applications.

17. The article of claim 16, wherein the containers are created in accordance with a Docker standard.

18. The article of claim 16, wherein the containers are created in accordance with a Kubernetes standard.
